(19) United States
(12) Patent Application Publication
(10) Pub. No.: US 2016/0189886 A1
(43) Pub. Date: Jun. 30, 2016

(54) SLIDING ELECTRIC COMPONENT

(71) Applicant: TOKYO COSMOS ELECTRIC CO., LTD., Kanagawa (JP)

(72) Inventor: Noritaka TERASAWA, Kanagawa (JP)

(21) Appl. No.: 14/908,681

(22) PCT Filed: Aug. 2, 2013
(86) PCT No.: PCT/JP2013/004698

§ 371 Date: Jan. 29, 2016

(51) Int. Cl. H01H 1/027; H01H 15/06; H01H 1/36

(52) U.S. Cl. CPC H01H 1/027; H01H 1/36; H01H 15/06

(57) ABSTRACT

Provided is a sliding electric component that extends the service life of a slider, inhibits the occurrence of abnormal sounds during sliding, smooths the sliding of the slider, and inhibits the occurrence of abrasion powder from carbon paste. The sliding electric component comprises a first power collection part (12), a second power collection part (13), and a slider (15) for sliding on the first power collection part (12) and the second power collection part (13), wherein the a plurality of areas (12a, 13a) composed of carbon paste are formed in the sliding direction of the slider (15) in continuous fashion on the second power collection part (13) on which the slider (15) slides.

### TECHNICAL FIELD

The present invention relates to a sliding electric component such as a potentiometer or switch provided with a wiper.

### BACKGROUND ART

Switch circuits each configured to electrically connect or disconnect between terminals via sliding of a wiper on a power collecting portion or an insulator have been widely used. For example, Patent Literature (hereinafter, referred to as “PTL”) 1 and PTL 2 each disclose an example of the switch circuit.

PTL 1 discloses a technique that forms the insulator by cutting a power collecting portion formed on an insulating substrate. In addition, PTL 2 discloses a technique that forms the insulator by forming a comb-shaped power collecting portion on an insulating substrate.

FIG. 11 is a schematic diagram of a switch circuit according to the related art. This switch circuit includes first and second terminals 1 and 2, first and second power collecting portions 3 and 4, and insulator 5, and wiper 6. First and second power collecting portions 3 and 4 are each formed of an etched metal foil or a metal part or conductive coating material such as silver.

When wiper 6 made of metal is positioned in contact with first and second power collecting portions 3 and 4, the switch is in a closed state where first and second terminals 1 and 2 are in electric conduction. Meanwhile, when wiper 6 is positioned in contact with first power collecting portion 3 and insulator 5, the switch is in an open state where first and second terminals 1 and 2 are not in electric conduction.

FIG. 12 is a diagram illustrating the relationship between the output of the switch circuit and a sliding distance of wiper 6. When wiper 6 is positioned on power collecting portion 4, the switch is in the closed state, so that the output of the switch is 100%. When wiper 6 slides to the position of insulator 5, the switch turns into the closed state, and the output of the switch becomes zero.

When wiper 6 slides on first and second power collecting portions 3 and 4, there may be noise and/or unsmooth sliding due to friction between the metals. Moreover, the life of wiper 6 being slidable may be reduced. For this reason, carbon paste excellent in slidability is often applied to the entire surfaces of first and/or second power collecting portions 3 and 4.

### CITATION LIST

### Patent Literature

PTL 1

Japanese Utility Model (Registration) Application Laid-Open No. HEI 2-136304

PTL 2

Japanese Utility Model (Registration) Application Laid-Open No. HEI 3-26021

### SUMMARY OF INVENTION

### Technical Problem

When the carbon paste is applied to the entire surfaces of first and/or second power collecting portions 3 and/or 4, the applied carbon paste generates abrasion powder. The generated abrasion powder easily scatters, and when the abrasion powder scatters to insulator 5, the insulation quality of insulator 5 may degrade.

The present invention has been made in order to solve the problem mentioned above and thus aims to provide a sliding electric component capable of extending the life of a wiper, suppressing noise during sliding, making the wiper slide smoothly, and suppressing the generation of abrasion powder from carbon paste.

### Solution to Problem

The present invention can provide a sliding electric component including: a first power collecting portion; a second power collecting portion; and a wiper configured to slide on the first and the second power collecting portions, in which a plurality of regions each made of carbon paste are formed on the second power collecting portion where the wiper slides, the plurality of regions being intermittently formed in a direction in which the wiper slides.

### Advantageous Effects of Invention

According to the present invention, it is made possible to extend the life of a wiper, suppress noise during sliding, make the wiper slide smoothly, and suppress the generation of abrasion powder from carbon paste.

### BRIEF DESCRIPTION OF DRAWINGS

FIG. 1 is a diagram illustrating an exemplary configuration of a sliding electric component according to an embodiment of the present invention;

FIG. 2 is a diagram illustrating a relationship between the shape of a wiper and a carbon paste formation pattern;

FIG. 3 is a diagram illustrating a relationship between the shape of a wiper and a carbon paste formation pattern;

FIG. 4 is a diagram illustrating a relationship between the shape of a wiper and a carbon paste formation pattern;

FIG. 5 is a diagram illustrating a relationship between the shape of a wiper and a carbon paste formation pattern;

FIG. 6 is a diagram illustrating a relationship between the shape of a wiper and a carbon paste formation pattern;

FIG. 7 is a diagram illustrating a relationship between the shape of a wiper and a carbon paste formation pattern;

FIG. 8 is a diagram illustrating an exemplary configuration of a potentiometer with a switch;

FIG. 9 is a diagram for describing a position where a carbon paste region is formed;

FIG. 10 is a diagram for describing a position where a carbon paste region is formed;

FIG. 11 is a schematic diagram of a switch circuit of the related art; and

FIG. 12 is a diagram illustrating a relationship between the output of a switch circuit and a sliding distance of a wiper.

### DESCRIPTION OF EMBODIMENT

Hereinafter, a description will be given of an embodiment of the present invention with reference to the drawings.

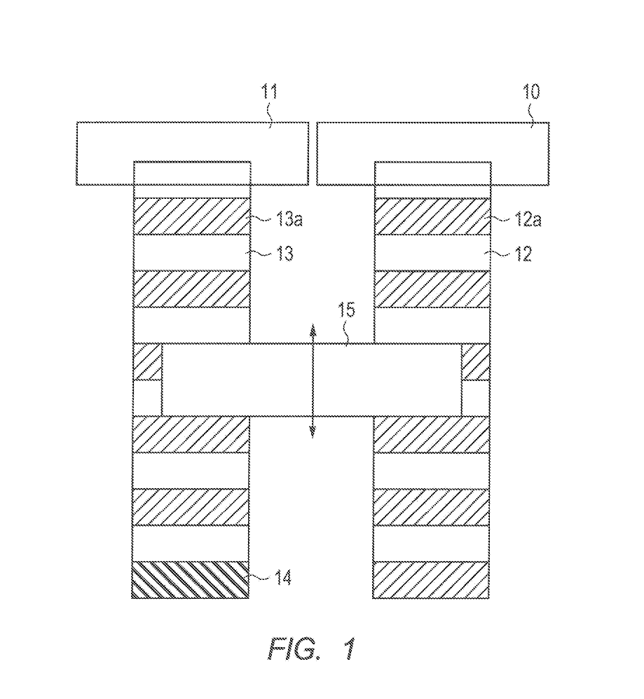

FIG. 1 is a diagram illustrating an exemplary configuration of a sliding electric component according to the embodiment of the present invention. As illustrated in FIG. 1, this sliding electric component includes first and second terminals 10 and 11, first and second power collecting portions 12 and 13, insulator 14, and wiper 15. First and second power collecting portions 12 and 13 are each formed of an etched metal foil or a metal part or conductive coating material such as silver

When wiper 15 made of metal is positioned in contact with first and second power collecting portions 12 and 13, the switch is in a closed state where first and second terminals 10 and 11 are in electrical conduction. Meanwhile, when wiper 15 is positioned in contact with first power collecting portion 12 and insulator 14, the switch is in an open state where first and second terminals 10 and 11 are not in electrical conduction.

Carbon paste regions 12a and 13a having conductivity are intermittently formed in a direction in which wiper 15 slides. Carbon paste regions 12a are formed on the surface of first power collecting portion 12 to be in contact with wiper 15 while carbon paste regions 13a are formed on the surface of second power collecting portion 13 to be in contact with wiper 15.

The formation of carbon paste regions 12a and 13a excellent in slidability can extend the life of slidability of wiper 15 twice as long as that of the related art. Moreover, it is made possible to suppress the noise that is generated when wiper 15 slides. Furthermore, the frictional coefficient becomes so small that wiper 15 slides smoothly.

Furthermore, forming carbon paste regions 12a and 13a intermittently can suppress the generation of abrasion powder. Thus, an increase in the contact resistance value between wiper 15 and first power collecting portion 12 or second power collecting portion 13 can be suppressed. Furthermore, the amount of abrasion powder that scatters to insulator 14 can be reduced, so that insulator 14 can be prevented from decreasing in insulation quality. Thus, the switch increases in reliability.

Note that, although carbon paste regions 12a and 13a are formed on the surfaces of both first and second power collecting portions 12 and 13 in the example of FIG. 1, carbon paste regions 12a and 13a may be formed on the surface of only one of first and second power collecting portions 12 and 13. The advantageous effects of the present application mentioned above can be obtained about in this case as well.

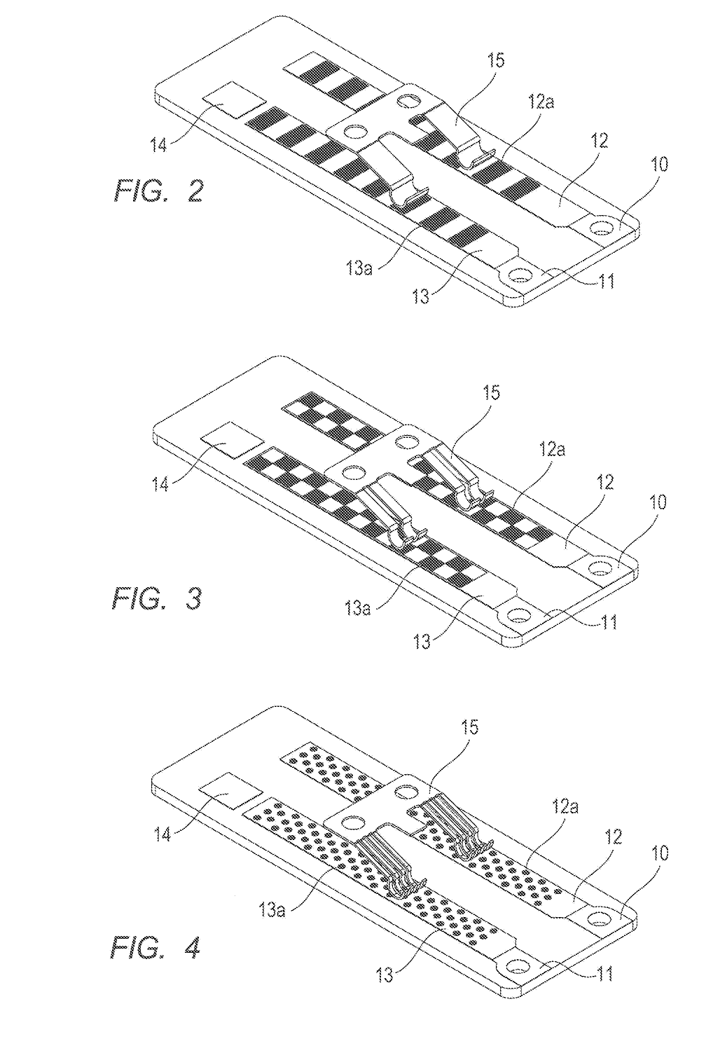

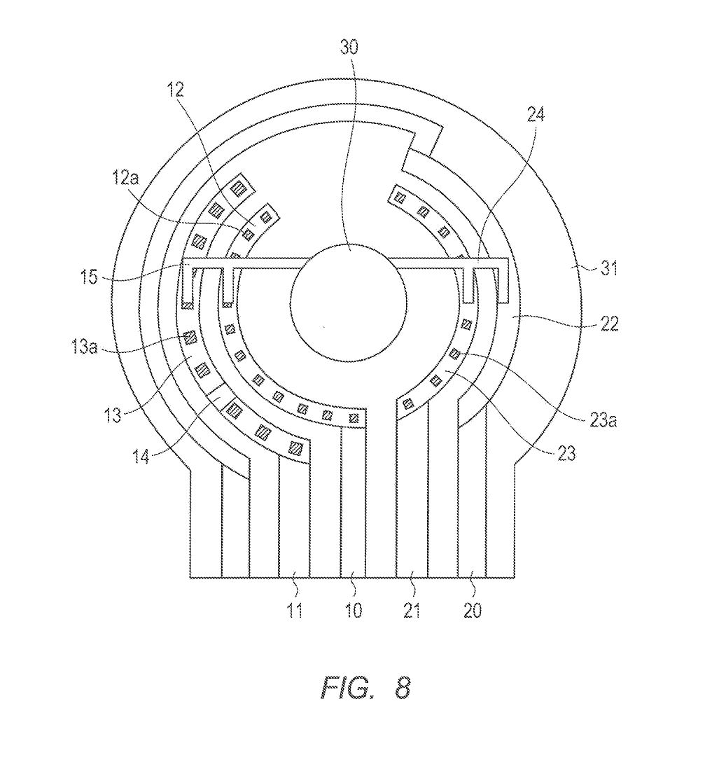

FIGS. 2 to 7 are diagrams each illustrating a relationship between the shape of wiper 15 and a carbon paste formation pattern. When wiper 15 includes two metal brushes as illustrated in FIG. 2, a pattern is formed in which one of the metal brushes intermittently comes into contact with carbon paste regions 12a while the other brush intermittently comes in contact with carbon paste regions 13a with sliding of wiper 15.

When wiper 15 includes four metal brushes as illustrated in FIG. 3, a pattern is formed likewise in which two of the four metal brushes intermittently come in contact with carbon paste regions 12a while the other two brushes intermittently come in contact with carbon paste regions 13a. In the case of FIG. 3, two of the four metal brushes are always in contact with carbon paste regions 12a and 13a. For this reason, the slidability of wiper 15 can be kept in uniform regardless of the position of wiper 15.

In addition, a dotted pattern in which circular carbon paste regions 12a and 13a are spread may be employed as illustrated in FIG. 4. This pattern reduces the total area of carbon paste regions 12a and 13a, so that it is made possible to significantly suppress the generation of abrasion powder while suppressing degradation in slidability of wiper 15.

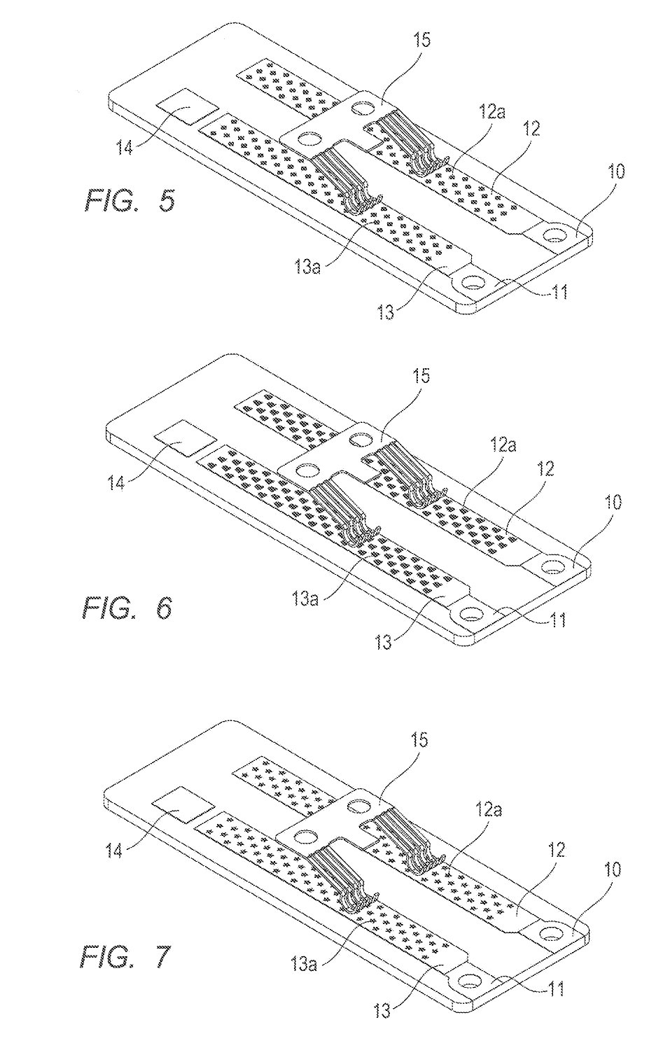

Moreover, as illustrated in FIGS. 5 to 7, carbon paste regions 12a and 13a may be each formed in a rhombus, trapezoid or star shape or a shape other than these shapes. In this case as well, it is made possible to significantly suppress the generation of abrasion powder while suppressing degradation in slidability of wiper 15 as in the case where carbon paste regions 12a and 13a are each formed in a circular shape.

Furthermore, although first and second power collecting portions 12 and 13 are each formed in a linear shape in FIGS. 1 to 7, these portions do not have to be formed in a linear shape. In addition, although FIGS. 1 to 7 illustrate switch circuits, the present invention is applicable to other sliding electric components such as a potentiometer, for example.

FIG. 8 is a diagram illustrating an exemplary configuration of a potentiometer with a switch. This potentiometer provided with a switch includes first and second terminals 10 and 11, first and second power collecting portions 12 and 13, insulator 14, wiper 15, third and fourth terminals 20 and 21, resistor 22, third power collecting portion 23, wiper 24 and rotating body 30, which are placed on insulating substrate 31.

Wipers 15 and 24 are attached to rotating body 30. Rotating body 30 is rotatably supported by insulating substrate 31.

First and second terminals 10 and 11, first and second power collecting portions 12 and 13, insulating body 14, wiper 15, and carbon paste regions 12a and 13a are identical to the elements of the switch circuit described with FIGS. 1 to 7.

In the example of FIG. 8, however, first and second power collecting portions 12 and 13 are each formed in an arc shape. Moreover, carbon paste regions 12a and 13a are formed intermittently in a direction in which wiper 15 slides. Thus, the advantageous effects described in the cases of FIGS. 1 to 7 can be obtained.

Meanwhile, third and fourth terminals 20 and 21, resistor 22, third power collecting portion 23 and wiper 24 form a potentiometer. Resistor 22 is formed of a carbon resistor, for example. Moreover, third power collecting portion 23 is formed of an etched metal foil or a metal part or conductive coating material such as silver

In addition, the resistor value between third terminal 20 and fourth terminal 21 can be changed by sliding wiper 24 made of metal while wiper 24 is in contact with both resistor 22 and third power collecting portion 23.

Furthermore, carbon paste regions 23a having conductivity are formed intermittently on third power collecting portion 23 in a direction in which wiper 24 slides. Thus, the same effects as those described in the cases in FIGS. 1 to 7 can be obtained.

Note that, carbon paste regions 12a, 13a and 23a may be formed from the edges of first, second and third power collecting portions 12, 13 and 23 with a predetermined interval.

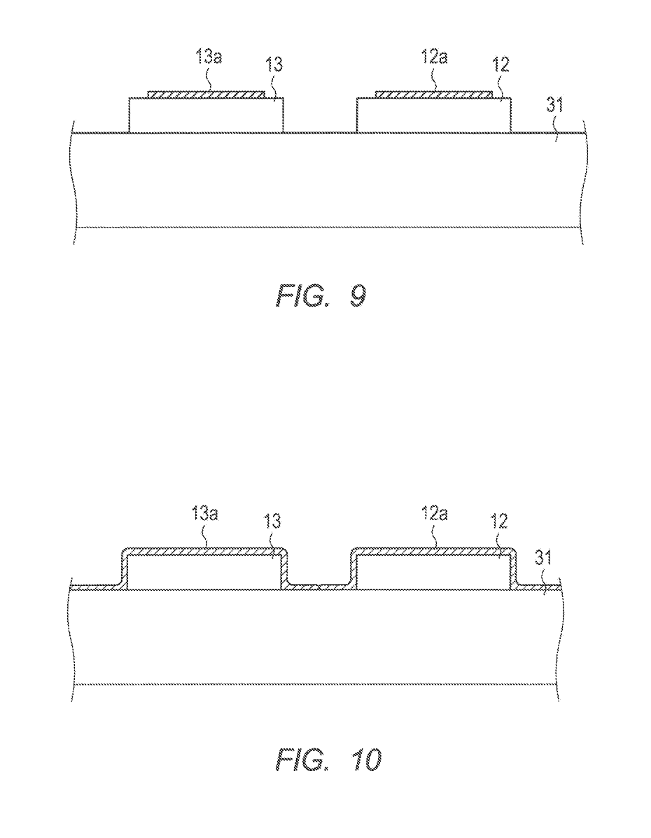

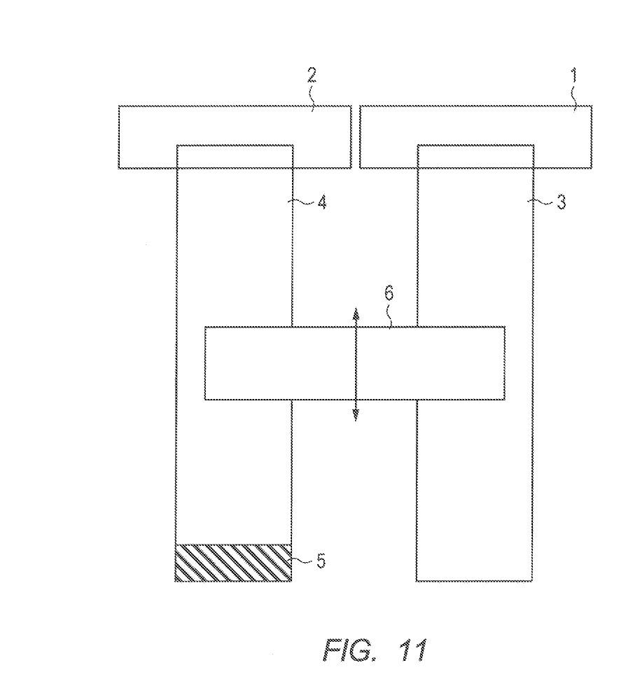

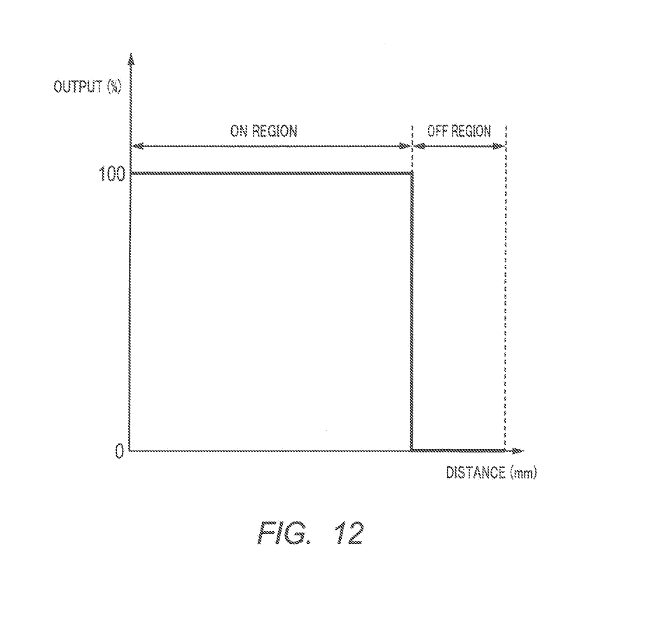

FIGS. 9 and 10 are diagrams for describing the positions where carbon paste regions 12a and 13a are formed. FIGS. 9 and 10 each illustrate a cross section of first and second power collecting portions 12 and 13 in a short-side direction, where carbon paste regions 12a and 13a are formed.

In the example of FIG. 9, carbon paste regions 12a are formed from the edge of first power collecting portion 12 in the short-side direction with a predetermined interval while carbon paste regions 13a are formed from the edge of second power collecting portion 13 in the short-side direction with a predetermined interval. In this case, even when carbon paste regions 12a and 13a are somewhat shifted in position due to manufacturing variations, the possibility of first and second power collecting portions 12 and 13 being electrically connected with each other is low.

Meanwhile, when carbon paste regions 12a and 13a are formed without the interval mentioned above, first and second power collecting portions 12 and 13 may be electrically connected with each other due to manufacturing variations. For example, as illustrated in FIG. 10, carbon paste region 12a may extend to carbon paste region 13a and cause first power collecting portion 12 and second power collecting portion 13 to be electrically connected with each other.

Because of the concern mentioned above, carbon paste regions 12a are formed from a the edge of first power collecting portion 12 in the short-side direction with a predetermined interval while carbon paste regions 13a are formed from the edge of second power collecting portion 13 in the short-side direction with a predetermined interval. Thus, the insulation quality between first and second power collecting portions 12 and 13 can be ensured.

As has been described above, the sliding electric component according to the embodiment is capable of extending the life of the wiper, suppressing noise during sliding, making the wiper slide smoothly, and suppressing the generation of abrasion powder from carbon paste.

### INDUSTRIAL APPLICABILITY

The sliding electric component according to the present invention is suitable for use as a sliding electric component such as a potentiometer or switch provided with a wiper.

### REFERENCE SIGNS LIST

1, 10 First terminal

2, 11 Second terminal

3, 12 First power collecting portion

4, 13 Second power collecting portion

5, 14 Insulator

6, 15, 24 Wiper

12a, 13a, 23a Carbon paste region

20 Third terminal

21 Fourth terminal

22 Resistor

23 Third power collecting portion

30 Rotating body

31 Insulating substrate

1. A sliding electric component comprising:
a first power collecting portion;
a second power collecting portion; and
a wiper configured to slide on the first and the second power collecting portions, wherein:
a plurality of regions each composed of carbon paste are formed on the second power collecting portion where the wiper slides, the plurality of regions being intermittently formed in a direction in which the wiper slides.

2. The sliding electric component according to claim 1, wherein the regions composed of carbon paste each have a rectangular shape.

3. The sliding electric component according to claim 1, wherein the plurality of regions composed of carbon paste form a plurality of rows, and the plurality of regions composed of carbon paste included in adjacent rows are alternately disposed.

4. The sliding electric component according to claim 1, wherein the plurality of regions composed of carbon paste are dispersedly disposed.

5. The sliding electric component according to claim 4, wherein the regions composed of carbon paste each have a circular shape.

6. The sliding electric component according to claim 4, wherein the regions composed of carbon paste each have a rhombus shape.

7. The sliding electric component according to claim 4, wherein the regions composed of carbon paste each have a trapezoidal shape.

8. The sliding electric component according to claim 4, wherein the regions composed of carbon paste each have a star shape.

9. The sliding electric component according to claim 1, wherein the plurality of regions composed of carbon paste are formed with a predetermined interval from an edge of the second power collecting portion in a short-side direction of the second power collecting portion.

10. The sliding electric component according to claim 1, further comprising an insulating portion at a position which is adjacent to the second power collecting portion and where the wiper slides.

11. The sliding electric component according to claim 1, wherein the plurality of regions composed of carbon paste are formed on the first power collecting portion where the wiper slides, the plurality of regions being intermittently formed in a direction in which the wiper slides.
